(19) United States
(12) Patent Application Publication
(10) Pub. No.: US 2026/0274640 A1
(43) Pub. Date: Sep. 17, 2026

(54) MECHANICAL CARBONATED BEVERAGE DISPENSING SYSTEM

(71) Applicant: THE COCA-COLA COMPANY, Atlanta, GA (US)

(72) Inventors: Damian James Reec MYCROFT, Decatur, GA (US); Ginger V. ODUM, Atlanta, GA (US); Shriya PATEL, Lilburn, GA (US); Jevawn Sebastian ROBERTS, Tucker, GA (US); Mary Jo DUBINA, Brookhaven, GA (US); Brian Bellamy JOHNSON, Roswell, GA (US); Jeffrey Daniel ULCHAK, Belmont, MA (US); David Alfred SIMM, Westfield, MA (US)

(21) Appl. No.: 18/874,002

(22) PCT Filed: Jun. 15, 2023
(86) PCT No.: PCT/US2023/025425

§ 371 Date: Dec. 11, 2024

Related U.S. Application Data
(60) Provisional application No. 63/356,678, filed on Jun. 29, 2022.

(51) Int. Cl. B67D 1/00; B67D 1/12

(52) U.S. Cl. CPC B67D 1/0021; B67D 1/0046; B67D 1/0058; B67D 1/1252; B67D 2210/00036

(57) ABSTRACT

A mechanical drink dispensing system includes a first tank fluidically coupled to a second tank to provide a fluid to the second tank. A valve is positioned on an outlet of the second tank and configurable between an open and closed position responsive to manipulation of an actuator by a user. When the valve is in the open position, a pump operated by compressed CO₂ gas is configured to transfer the fluid from the first tank to the second tank. In the second tank, the fluid is carbonated by the compressed CO₂ gas. The system further includes an additive cartridge slot sized to receive additive packages containing additives, and a mixing chamber adapted to receive the carbonated fluid from the second tank and additives from the additive cartridge slot to generate and dispense a mixed beverage of the fluid and additives.

### CROSS-REFERENCE TO RELATED APPLICATIONS

This application is a continuation of U.S. Provisional Patent Application No. 63/356,678 filed Jun. 29, 2022, which is incorporated herein by reference in its entirety.

### BACKGROUND

The present disclosure relates generally to a beverage dispensing system, and more specifically to a mechanical beverage dispensing system that produces and dispenses carbonated beverages.

Carbonated and/or flavored water beverages have been an increasingly popular choice for many people that seek to drink more water. In many cases, carbonated and flavored water beverages are sold to consumers in pre-mixed packs or cases of cans or bottles. Traditionally-packaged carbonated and flavored water beverages can be inconvenient to replenish, often requiring the consumer to travel to a store for purchasing and further requiring a significant amount of space in the consumer's home refrigerator. Lately, at-home carbonation units and beverage dispensers have become a desirable alternative to canned or bottled carbonated and flavored water beverages; however, many currently available at-home carbonation units and beverage dispensers have a large footprint (e.g., taking up valuable counterspace in a consumer's home), require external power for chilling and/or dispensing a beverage, and require a user to manually add and mix additives, such as flavorings. Additionally, many currently available at-home carbonation units and beverage dispensers require users to make a large “batch” of carbonated and flavored beverage (e.g., one to two liters at a time) and therefore lack the ability to produce carbonated and flavored water beverages on demand and at the user's convenience.

### SUMMARY

One implementation of the present disclosure is a mechanical drink dispensing system. The system includes a first tank for holding a first fluid; a second tank fluidically coupled to the first tank; a carbonator fitting adapted to connect to a carbon dioxide (CO₂) tank; a valve positioned on an outlet of the second tank and configurable between an open and closed position; an actuator mechanically coupled to the valve and configured to actuate the valve between the open and closed positions upon physical manipulation of the actuator by a user; a pump for transferring the first fluid from the first tank to the second tank when the valve is in the open position; a first compressed CO₂ pathway from the carbonator fitting to the pump, the pump configured to operate by compressed CO₂ gas; a second compressed CO₂ pathway from the carbonator fitting to the second tank, the first fluid being carbonated by the compressed CO₂ gas in the second tank; an additive cartridge slot sized to receive one or more additive packages containing one or more additives; and a mixing chamber including a mixing area and an outlet, the additive cartridge slot in fluid communication with the mixing chamber, the mixing area being adapted to receive the carbonated first fluid from the second tank and the one or more additives from the additive cartridge slot when the valve is in the open position, and the outlet configured to dispense a beverage including a mixture of the first fluid and the one or more additives.

In some embodiments, the mixing area includes a bowl, and the outlet is integrated into the bowl.

In some embodiments, the mixing area includes a second valve, such as a Venturi valve, fluidically coupled to the additive cartridge slot.

In some embodiments, the system further includes a linkage that mechanically couples the actuator with the additive cartridge slot, the linkage configured to manipulate the additive cartridge slot to cause at least one of the one or more additives to be dispensed into the mixing area when the actuator is physically manipulated by the user.

In some embodiments, the system further includes a third compressed CO₂ pathway from the carbonator fitting to the additive cartridge slot, the third compressed CO₂ pathway including a second valve positioned between the carbonator fitting and the additive cartridge slot. In such embodiments, the actuator is further mechanically coupled to the second valve and configured to actuate the second valve between an open and a closed position upon physical manipulation of the actuator by the user.

In some embodiments, each of the first compressed CO₂ pathway and the second compressed CO₂ pathway include an in-line pressure regulator.

In some embodiments, the system further includes a filter for filtering the first fluid, the filter positioned internally to, and at an outlet of, the first tank.

In some embodiments, system is unrefrigerated.

In some embodiments, the system is sized to fit on a shelf of a residential refrigerator. In some embodiments, the system is configured to be stored in a cooled environment such that the first fluid reaches an equilibrium with a temperature of the cooled environment.

In some embodiments, the temperature of the cooled environment ranges from 35° F. to 38° F.

In some embodiments, the temperature of the cooled environment is below 40° F.

Another implementation of the present disclosure is a method for mixing and dispensing a carbonated beverage using a beverage dispensing device. The method includes receiving a user input to an actuator of the beverage dispensing device, the actuator being mechanically coupled to a valve of the beverage dispensing device and the user input causing the actuator to actuate the valve from a closed position to an open position; when the valve is in the open position: transferring water from a fluid tank of the beverage dispensing device to a carbonation tank of the beverage dispensing device using a pump powered by compressed carbon dioxide (CO₂); carbonating the water in the carbonation tank using the compressed CO₂; transferring the carbonated water from the carbonation tank to a mixing chamber of the beverage dispensing device, the mixing chamber including a mixing area and an outlet; dispensing, into the mixing area of the mixing chamber, one or more additives from one or more additive cartridges, the carbonated water and the one or more additives being mixed within the mixing area; and dispensing, from the outlet of the mixing chamber, the carbonated beverage including the mixture of the carbonated water and the one or more additives.

In some embodiments, the one or more additive cartridges are contained within an additive cartridge slot of the beverage dispensing device.

In some embodiments, the mixing area includes a Venturi valve and the Venturi valve is fluidically coupled to the additive cartridge slot such that the one or more additives are dispensed into the Venturi valve responsive to the carbonated water passing through the Venturi valve.

In some embodiments, the actuator is further mechanically coupled to the additive cartridge slot via a linkage and, responsive to the user input, the linkage manipulates the additive cartridge slot to cause at least one of the one or more additives to be dispensed into the mixing area. In some embodiments, the method further includes filtering the water as the water is transferred from the fluid tank to the carbonation tank, the water being filtered by a filter positioned at an outlet of the fluid tank.

In some embodiments, the actuator is a mechanical actuator.

In some embodiments, the beverage dispensing device is configured to be stored in a cooled environment such that the water reaches an equilibrium with a temperature of the cooled environment.

In some embodiments, the beverage dispensing device is unrefrigerated.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIGS. 1-5 are diagrams showing various configurations of a mechanical carbonated beverage dispensing system, according to some embodiments.

FIG. 6 is a diagram illustrating one implementation of the carbonation system used in the mechanical carbonated beverage dispensing system of FIGS. 1-5, according to some embodiments.

FIG. 7 is a diagram showing one implementation of the mechanical carbonated beverage dispensing system of FIGS. 1-5, according to some embodiments.

FIG. 8 is a diagram showing an alternative implementation of the mechanical carbonated beverage dispensing system of FIGS. 1-5, according to some embodiments.

FIG. 9 is a diagram of the mechanical carbonated beverage dispensing system of FIGS. 1-5 in an example storage environment, according to some embodiments.

FIGS. 9A and 9B are diagrams of a combined mixing bowl and outlet for mixing a fluid and one or more additives, according to some embodiments.

FIGS. 10A and 10B are example diagrams showing an implementation of the mixing chamber and/or outlet of the mechanical carbonated beverage dispensing system of FIGS. 1-5, according to some embodiments.

FIGS. 11 and 12 are example implementations of an in-line carbonation system and a batch carbonation system used by the mechanical carbonated beverage dispensing system of FIGS. 1-5, respectively, according to some embodiments.

### DETAILED DESCRIPTION

Referring generally to the figures, a mechanical beverage dispensing system is shown, accordingly to various embodiments. The mechanical beverage dispensing system described herein may include a first tank for holding a fluid (e.g., water or other diluent) and a carbonation system. In some embodiments, the carbonation system includes a second “carbonation tank” in which the fluid is carbonated. The fluid may be transferred through the system using a carbon dioxide (CO₂) powered pump. For example, the pump may transfer the fluid from the first tank and into the second tank for carbonation of the fluid. Alternatively, the system includes an in-line carbonation system that, likewise, operates solely on CO₂ power. The system may be controlled, in part, by a mechanical switch (i.e., actuator) that is manipulated by a user such that, when the mechanical switch is depressed, the carbonated fluid flows from the second tank or the carbonation system and into a mixing chamber, where it mixed with one or more additives (e.g., flavorings).

Unlike other at-home carbonation units and beverage dispensers, as discussed above, the mechanical beverage dispensing system described herein is entirely mechanical and therefore does not require an external power source. For example, instead of requiring electrical power to operate a pump, fluid is transferred throughout the system and additives are dispensed using compressed CO₂ and/or mechanical action of the actuator. The mechanical beverage dispensing system may be sized to fit in a standard residential refrigerator in order to maintain the fluid (e.g., water) at a cooled temperature, rather than requiring a separate or built-in refrigeration unit. Accordingly, the mechanical beverage dispensing system described herein may be much more energy efficient and compact than existing at-home carbonation units and beverage dispensers.

In addition, as mentioned above, the mechanical beverage dispensing system may dispense additives (e.g., flavorings, vitamins, minerals, electrolytes, etc.) from replaceable or refillable additive cartridges. In this manner, the system may produce enhanced (e.g., flavored, vitamin-enhanced, etc.), carbonated beverages on-demand with minimal user input. In various implementations, the additive cartridges are unsweetened or non-nutritively sweetened additives, thereby ensuring small (e.g., 12 oz or less, 10 oz or less, 8 oz or less, 5 oz or less, 3 oz or less, 1 oz or less) cartridge sizes. By providing small cartridge sizes, the mechanical beverage dispensing system may dispense multiple different enhanced beverages (e.g., lemon flavored sparkling water, vitamin enhanced sparkling water, etc.). These replaceable or refillable additive cartridges also have the advantage of using smaller packaging than pre-mixed beverages, thereby reducing waste, lowering costs and emissions due to shipping, and allowing users greater customization options. Additional features and advantages of the mechanical beverage dispensing system are described in greater detail in the examples provided below.

### Overview

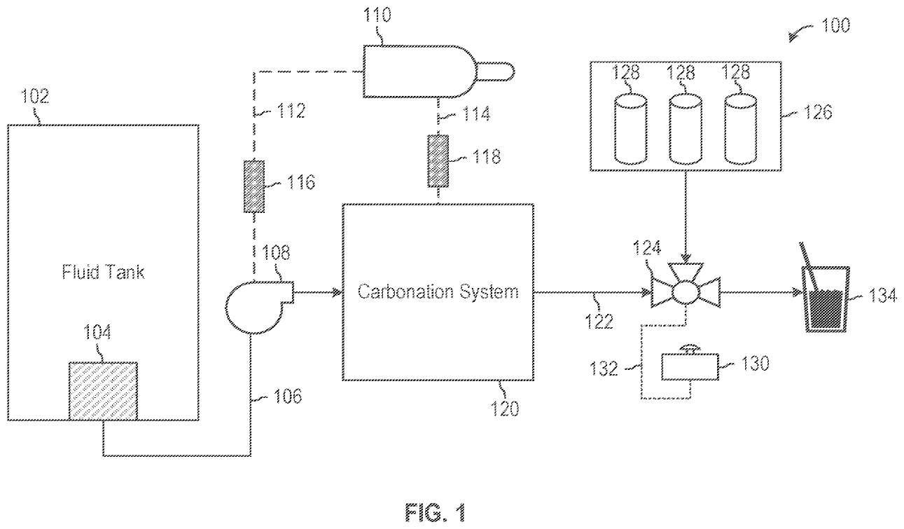

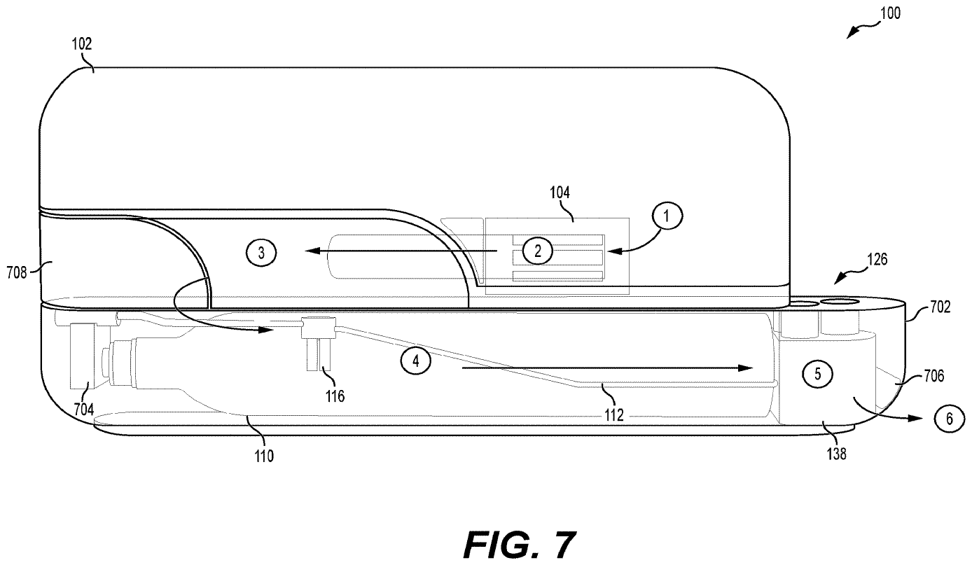

Referring generally to FIGS. 1-5, block diagrams of different configurations of a mechanical carbonated beverage dispensing system 100 are shown, according to various embodiments. As described above, system 100 may generally be configured to produce carbonated and additive-enhanced beverages on-demand. System 100 includes a first tank, shown as fluid tank 102, for holding a fluid. In general, the fluid is water; however, fluid tank 102 may be configured to hold other fluids such as coffee, tea, juice, and the like. Fluid tank 102 may, accordingly, be constructed of any food-safe or food-grade material, such a metal, glass, or plastic. In some embodiments, fluid tank 102 is transparent or translucent such that a user can view a level of the fluid contained in fluid tank 102 (e.g., as shown in FIG. 7). In other embodiments, fluid tank 102 may include an indicator for displaying the fluid level. In some embodiments, fluid tank 102 includes a selectively removable or openable lid or cover (not shown) which, when opened or removed, provides an opening for fluid tank 102 to be filled with fluid. In some embodiments, fluid tank 102 is removably coupled to system 100 (e.g., to the downstream components of system 100) such that fluid tank 102 can be removed from system 100 to be filled with fluid.

In some embodiments, fluid tank 102 includes a filter 104 for filtering the fluid. Filter 104 may be, for example, an activated charcoal filter. In some embodiments, filter 104 is positioned internally to, and at an outlet of, fluid tank 102. Alternatively, filter 102 is positioned on a first fluid conduit 106 that extends from an outlet of fluid tank 104 to a pump 108. As described herein, first fluid conduit 106 may be any suitable tubing or piping for carrying the fluid. For example, first fluid conduit 106 may be flexible, food-grade plastic tubing (e.g., polyurethane, nylon, PVC, etc.). First fluid conduit 106 is generally coupled, on a first end, to the outlet of fluid tank 102 (e.g., using any suitable connector or fitting) and on a second end to an inlet of pump 108.

Generally, pump 108 is powered by compressed CO2 rather than electricity. As shown, compressed CO₂ can be delivered to pump 108 via a first compressed CO₂ pathway 112, which extends from a CO₂ canister 110 to pump 108. Accordingly, first compressed CO₂ pathway 112 can be formed of any material that is capable of containing a pressurized gas, such as aluminum or steel tubing. In some embodiments, a first pressure regulator 116 is positioned on (i.e., interrupting) first compressed CO₂ pathway 112 to regulate and/or control the pressure of the compressed CO₂ provided to pump 108. Put another way, the operation of pump 108 may be controlled by first pressure regulator 116. In other embodiments, first pressure regulator 116 is integrated into pump 108 rather than being a separate component positioned on first compressed CO₂ pathway 112. In some embodiments, first pressure regulator 116 is set to, or operates at, 90 psi.

System 100 is shown to further include a carbonation system 120 that is fluidically coupled to pump 108, and thereby fluid tank 102, such that carbonation system 120 receives fluid (e.g., water) from fluid tank 102. In general, the fluid may be infused with CO₂ (i.e., carbonated) provided via a second compressed CO₂ pathway 114, which extends from CO₂ canister 110 to carbonation system 120. Second compressed CO₂ pathway 114 can be formed of any material that is capable of containing a pressurized gas, such as aluminum or steel tubing. In some embodiments, a second pressure regulator 118 is positioned on (i.e., interrupting) second compressed CO₂ pathway 114 to regulate and/or control the amount of compressed CO₂ provided to carbonation system 120. In other embodiments, second pressure regulator 118 is integrated into carbonation system 120. In some embodiments, first pressure regulator 116 is set to, or operates at, 72.5 psi.

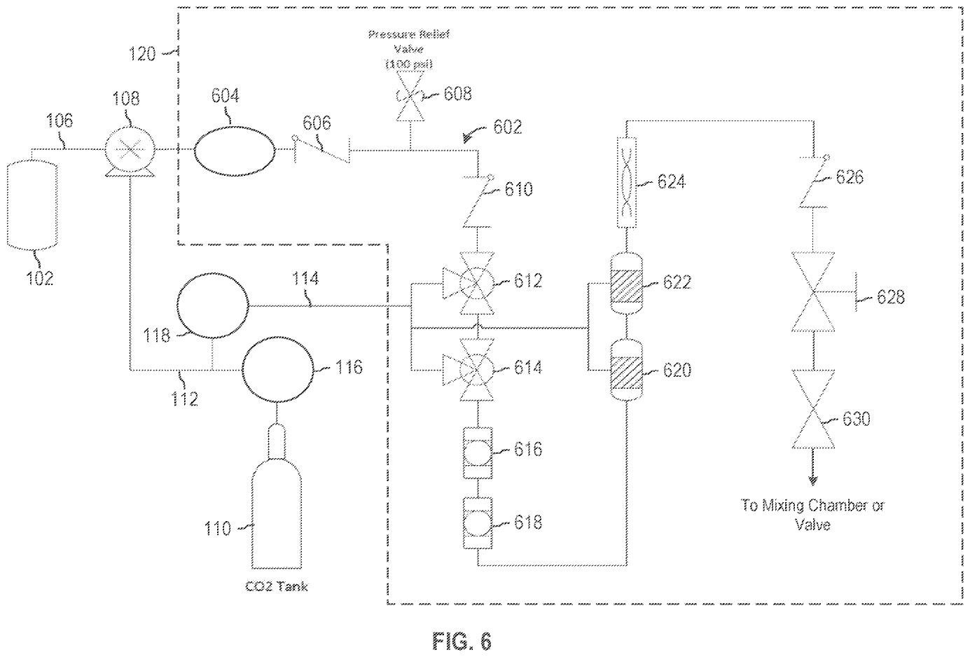

In some embodiments, carbonation system 120 is an “in-line carbonator” or in-line carbonation system. In other words, fluid flows from fluid tank 102 and through carbonation system 120 to be carbonated. An in-line carbonation system allows for the fluid to be carbonated continuously or on-demand. Additional description of carbonation system 120 in an in-line implementation is provided below with respect to FIG. 6. In other embodiments, carbonation system 120 is a batch carbonation system which includes a second fluid tank, also referred to as a “carbonation tank.” Like fluid tank 102, the carbonation tank may be constructed of any food-safe or food-grade material, such a metal, glass, or plastic. In some embodiments, the carbonation tank is transparent or translucent such that a user can view a level of fluid contained in the carbonation tank. In other embodiments, the carbonation tank may include an indicator for displaying the fluid level. Additional description of carbonation system 120 in an implementation having a carbonation tank is provided below with respect to FIG. 7.

Turning now to FIG. 1, in particular, a first configuration of system 100 is shown which includes a second fluid conduit 122 formed of food-grade tubing (e.g., aluminum, polyurethane, nylon, PVC, etc.) that extends from carbonation system 120 to a mixing valve 124, thereby fluidically coupling carbonation system 120 and mixing valve 124. In some embodiments, system 100 may include multiple of second fluid conduit 122 extending from carbonation system 120 to a single mixing valve 124, or to one or more individual mixing valves 124 (e.g., each corresponding to one of the multiple second fluid conduits 122). In some embodiments, the number of second fluid conduits 122 and/or mixing valves 124 corresponds to the number of slots in an additive cartridge slot 126, which is also fluidically coupled to mixing valve 124. In other words, system 100 may include a separate second fluid conduit 122 and/or mixing valve 124 for each of additive cartridges 128.

Each of additive cartridges 128 may contain one or more additives to be mixed with fluid from carbonation system 120. As described herein, “additives” may refer to any substance that can be mixed with a base fluid to produce an output fluid mixture. Additives may include, but are not limited to, flavor concentrate, sweeteners, acids, vitamins, probiotics, minerals, electrolytes, fiber, amino acids, protein, dairy products (e.g., milk, cream, etc.), coffee concentrates, tea concentrates, juice concentrates, alcohol, pharmaceuticals, supplements, and the like. In some embodiments, the additives are in a form to ensure adequate incorporation into the base fluid (e.g., liquid, gel, solution, suspension, colloid, etc.). Additives may be soluble or non-soluble. In some embodiments, additive cartridges 128 have at least one opening through which a contained additive is dispensed. In some embodiments, additive cartridges 128 hold about two ounces of additive (e.g., in a liquid form). In some embodiments, additive cartridges 128 contain more than one additive in multiple “compartments” or spaces. Various examples of additive cartridges 128 with multiple ingredient compartments are discussed in US Patent App. No. 2016/0318689, which is incorporated herein by reference in its entirety. Alternatively, each of additive cartridges 128 could have a single chamber with the additives stored therein.

Also shown is a mechanical actuator 130 that is mechanically coupled to mixing valve 124 through a linkage 132. In general, actuator 130 is configured to actuate mixing valve 124 between an open position and a closed position responsive to a user interaction (e.g., the user pushing on or otherwise manipulating mechanical actuator 130). In some implementations, a separate shut-off valve (not shown) may be positioned downstream of the mixing valve. The linkage 132 may be coupled to the shut-off valve such that actuation of the mechanical actuator 130 causes the shut-off valve to toggle between an open position and a closed position. As one example, actuator 130 is a push button that includes a spring for holding the push button in a first position (e.g., not depressed), although it should be appreciated that actuator 130 may be any suitable actuator, lever, button, etc., that can actuate mechanical actuator 130.

In some embodiments, actuator 130 is mechanically coupled to one or both of first pressure regulator 116 and second pressure regulator 118 (e.g., via separate linkages (not shown)) such that the pressure regulator(s) 116, 118 are operated responsive to a user input via mechanical actuator 130. In some embodiments, system 100 includes a plurality of mechanical actuators 130 (not shown), each coupled to either an individual mixing valve 124 or to a single, common mixing valve 124. For example, system 100 may include a separate actuator 130 corresponding to each slot in additive cartridge slot 126. In this manner, each actuator 130 may cause a different additive to be dispensed.

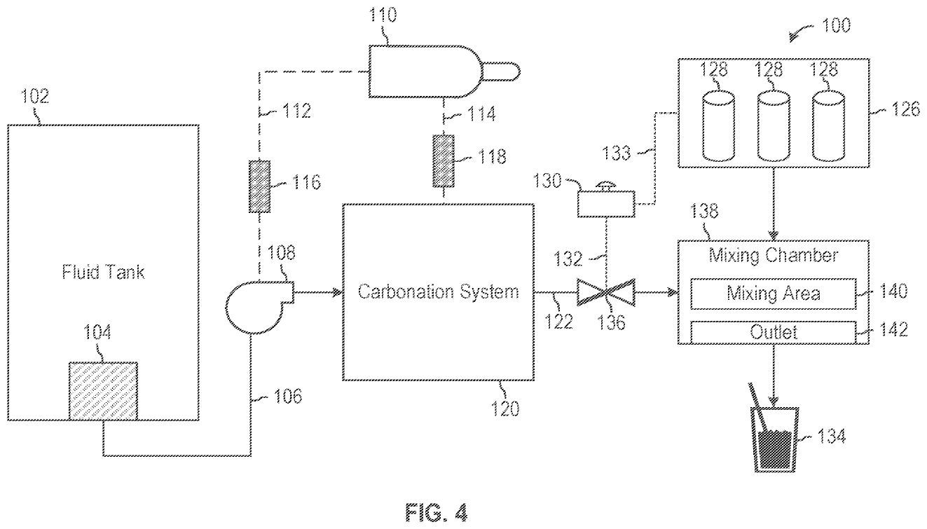

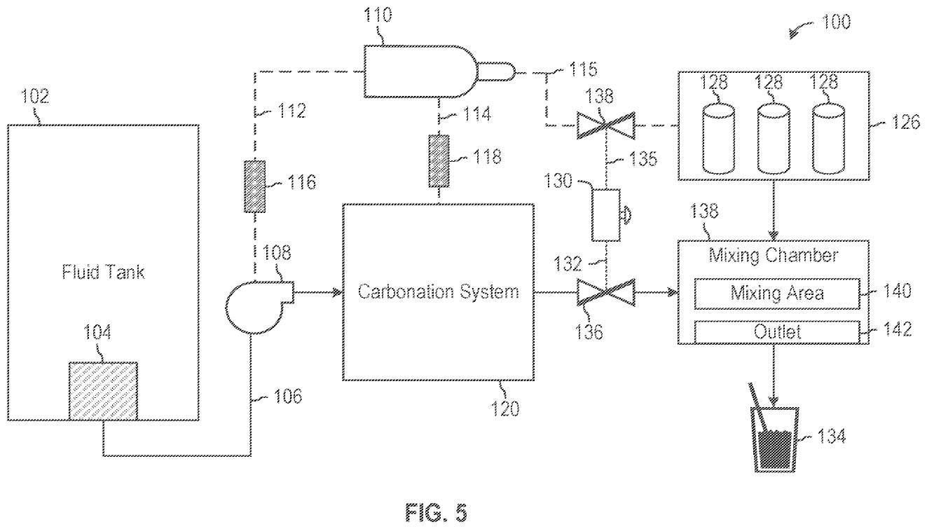

To cause system 100 to produce and dispense a carbonated and additive-enhanced beverage, hereinafter generally referred to as “mixed” beverage, the user may interact with actuator 130 (e.g., by depressing mechanical actuator 130) which opens mixing valve 124 or downstream shut-off valve. In turn, carbonated fluid (e.g., water) may flow from/through carbonation system 120, through mixing valve 124, and to an outlet of system 100, where it is dispensed into a vessel 134 (e.g., a bottle or glass). As the carbonated fluid passes through mixing valve 124, additive is drawn from the one or more additive cartridges due to the Venturi effect. In other words, mixing valve 124 may be a Venturi valve. Specifically, mixing valve 124 may have a middle portion that is smaller in diameter than the two end portions such that the flow rate of carbonated fluid through mixing valve 124 increases at the middle portion. This increased flow rate causes an area of low pressure to form at the middle portion of mixing valve 124, which can draw additive from the one or more additive cartridges 128. As the additive is dispensed, it may mix with the carbonated fluid prior to reaching an outlet of system 100 and being dispensed into vessel 134. In some embodiments, system 100 may further include a downstream mixing chamber (e.g., as shown in FIGS. 4 and 5) where the combined carbonated fluid and additives are further mixed before dispensing.

Prior to the mixed beverage dispensing, or while the mixed beverage is being mixed and dispensed, pump 108 may be activated (e.g., by first pressure regulator 116) to cause fluid to be transferred from fluid tank 102 and into carbonation system 120, where it is carbonated. For example, when carbonation system 120 is, or includes, a carbonation tank, pump 108 may be activated any time the fill level of the carbonation tank drops below a certain level. Alternatively, when carbonation system 120 is in-line, the fluid may be carbonated on-demand (e.g., only when actuator 130 is pressed). In some embodiments, pump 108 is activated automatically responsive to a drop in pressure in carbonation system 120 (e.g., due to mixing valve 124 being opened). In other embodiments, as mentioned above, actuator 130 is configured to operate one or both of first and second pressure regulators 116, 118 in order to activate pump 108 and to carbonate the fluid in carbonation system 120. In yet other embodiments, fluid is continuously transferred from fluid tank 102 to carbonation system 120 until the carbonation tank is full (e.g., as determined based on the internal pressure of the carbonation tank). Alternatively, in some embodiments, system 100 does not include pump 108 and, accordingly, fluid is automatically transferred from fluid tank 102 to carbonation system 120 as the carbonation tank empties or simply to fill the carbonation tank. For example, the fluid may be gravity-fed to carbonation system 120. Additional description of pump 108 and carbonation system 120 in an in-line implementation is provided below with respect to FIG. 6.

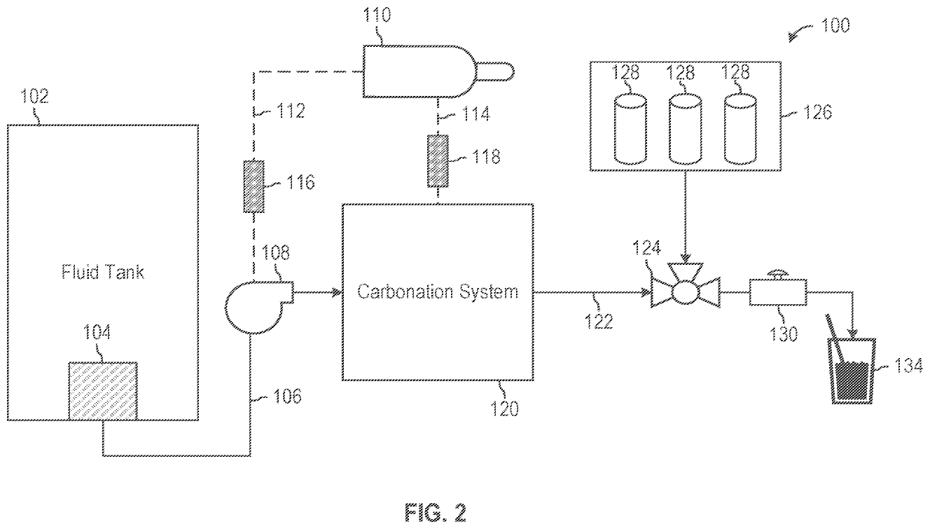

Turning now to FIG. 2, an alternative configuration of system 100 is shown in which actuator 130 is positioned at an outlet of mixing valve 124. Alternatively, actuator 130 can be positioned on second fluid conduit 122 between carbonation system 120 and mixing valve 124. In this manner, actuator 130 may be a shut-off valve to selectively allow or prevent the flow of carbonated fluid through mixing valve 124, which in turn selectively allows or prevents additive cartridges 128 from dispensing additive. It should be appreciated that other like components from earlier described configurations (e.g., FIG. 1) are structured and operate as described above and are not separately described again for the sake of brevity. For example, elements 102-122 shown in FIG. 2 are described in detail above with reference to FIG. 1.

In embodiments where system 100 includes multiple second fluid conduits 122 and/or mixing valves 124, each of the multiple second fluid conduits 122 and/or mixing valves 124 may include a separate mechanical actuator 130. For example, system 100 may include three mixing valves 124, each corresponding to one of three additive cartridges 128, and, correspondingly, three mechanical actuators 130. Other numbers of mixing valves 124, additive cartridges 123, and mechanical actuators 130 may be used. In this manner, when a user interacts with mechanical actuator 130, or one of multiple mechanical actuators 130, carbonated fluid may be permitted to flow through mixing valve 124, thereby causing additive cartridges 128 to dispense additive (e.g., due to the Venturi effect). In turn, the loss of pressure due to the carbonated fluid flowing out of system 100 (e.g., into vessel 134) may cause pump 108 to transfer additional fluid from fluid tank 102 and into carbonation system 120, where it is carbonated.

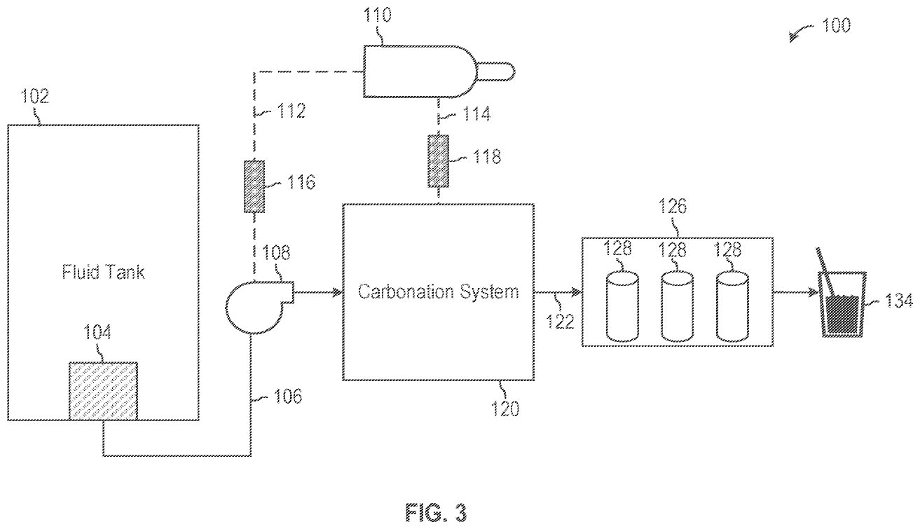

FIG. 3 shows yet another alternative configuration of system 100 in which additive cartridge slot 126, and the additive cartridges 128 contained therein, replace mixing valve 124 and mechanical actuator 130. In particular, each of additive cartridges 128 may act independently as a button or valve (e.g., similar in functionality to mechanical actuator 130) that can be depressed or otherwise manipulated by a user in order to cause the mixture and dispensing of a mixed beverage. Specifically, in some such embodiments, each of additive cartridges 128 may be positioned in a linearly actuating mounting or holder of additive cartridge slot 126 such that each of additive cartridges 128 can be manipulated between a first position (e.g., not depressed or “up”), to prevent the flow of carbonated fluid through additive cartridge slot 126, or a second position (e.g., depressed or “down”), to allow the flow of carbonated fluid.

To this point, additive cartridge slot 126 may include an inlet, to which second fluid conduit 122 is coupled, and an outlet from which the mixed beverage is dispensed. Alternatively, the outlet of additive cartridge slot 126 may be fluidically coupled to a separate mixing chamber for mixing of the combined carbonated fluid and dispensed additives. In any case, additive cartridge slot 126 may include a plurality of internal fluid pathways through which carbonated fluid can flow, each corresponding to one of additive cartridges 128. In this manner, when one of additive cartridges 128 are pressed or otherwise actuated by the user, the carbonated fluid may flow through the corresponding internal fluid pathway of additive cartridge slot 126, in the process causing additive to be dispensed from the additive cartridge 128. It should be appreciated that other like components from earlier described configurations (e.g., FIG. 1) are structured and operate as described above and are not separately described again for the sake of brevity. For example, elements 102-122 shown in FIG. 3 are described in detail above with reference to FIG. 1.

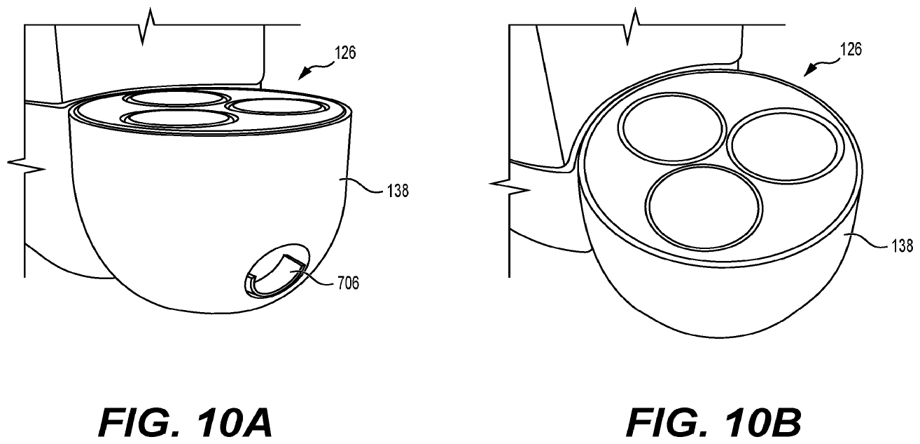

Referring now to FIG. 4, yet another alternative configuration of system 100 is shown, according to some embodiments. It should be appreciated that other like components from earlier described configurations (e.g., FIG. 1) are structured and operate as described above and are not separately described again for the sake of brevity. For example, elements 102-122 shown in FIG. 4 are described in detail above with reference to FIG. 1. In this configuration, system 100 is shown to include a mixing chamber 138 in fluid communication with carbonation system 120 via second fluid conduit 122. Mixing chamber 138 is further shown to be fluidically coupled to additive cartridge slot 126. In some embodiments, mixing chamber 138 includes a mixing area 140 in which additive and carbonated fluid are mixed. In some embodiments, the mixing area includes a bowl, as shown in FIGS. 10A and 10B, described in detail below.

Mixing chamber 138 can further include an outlet 142 from which the mixed beverage can be dispensed into vessel 134. It should also be appreciated that any of the configurations described above with respect to FIGS. 1-3 may include mixing chamber 138 positioned downstream of mixing valve 124, actuator 130, or additive cartridge slot 126.

Interrupting second fluid conduit 122, and thereby controlling the flow of carbonated fluid to mixing chamber 138, is a second valve 136. Second valve 136 may be actuated between an open position and a closed position by mechanical actuator 130 via linkage 132. Alternatively, the mechanical actuator 130 and the second valve 136 may be integrated together as a single unit and positioned on fluid conduit 122. In the closed position, second valve 136 may prevent carbonated fluid from flowing to mixing chamber 138 from carbonation system 120. In other words, second valve 136 is a shut-off valve.

In some embodiments, actuator 130 may also be mechanically coupled to additive cartridge slot 126 via a linkage 133. In some such embodiments, actuator 130 is further configured to cause one or more of additive cartridges 128 to dispense additive into mixing chamber 138. In some embodiments, system 100 includes multiple mechanical actuators 130, each corresponding to one of additive cartridges 128. In some such embodiments, each of the multiple mechanical actuators 130 may be coupled with the same second valve 136 or separate second valves 136.

In some embodiments, actuator 130 applies (e.g., via linkage 133), or causes additive cartridge slot 126 to apply, a compressive force to one or more of additive cartridges 128. For example, actuator 130 may manipulate additive cartridge slot 126 to squeeze at least one of additive cartridges 128, such as by contracting one or more of the side walls of a corresponding cartridge slot. In such embodiments, additive cartridges 128 may be at least partially flexible such that, when compressed, additive is dispensed. For example, the actuator 130 may cause (e.g., via linkage 133) a roller or plate to compress a portion of one of additive cartridges 128. In another example, actuator 130 may manipulate a plunger in additive cartridge slot 126 to cause at least one of additive cartridges 128 to dispense additive.

Put another way, to cause the configuration of system 100 shown in FIG. 4 to dispense a mixed beverage, a user may depress or otherwise manipulate actuator 130 which in turn opens second valve 136 via linkage 132, allowing carbonated fluid to flow from carbonation system 120 to mixing chamber 138. Concurrently, mechanical force may be transfer via linkage 132 to additive cartridge slot 126 which causes additive cartridge slot 126 to apply a compressive force, or other type of mechanical force, on at least one of additive cartridges 128. In turn, the additive cartridge 128 may dispense additive into mixing chamber 138, where it is mixed with the carbonated fluid and dispensed from an outlet of mixing chamber 138 into vessel 134.

Referring now to FIG. 5, yet another alternative configuration of system 100 is shown, according to some embodiments. It should be appreciated that other like components from earlier described configurations (e.g., FIG. 1) are structured and operate as described above and are not separately described again for the sake of brevity. For example, elements 102-122 shown in FIG. 5 are described in detail above with reference to FIG. 1. In this configuration, actuator 130 is shown to be coupled to a third valve 138 through a linkage 135 such that actuator 130, when manipulated by a user, actuates third valve 138 between an open and a closed position. Third valve 138 is also shown to be positioned on (i.e., interrupting) a third compressed CO₂ pathway 115, extending from CO₂ canister 110 to additive cartridge slot 126. In this manner, compressed CO₂ from CO₂ canister 110 can be provided to additive cartridge slot 126 in order to cause additive cartridge slot 126 to dispense one or more additives. As an example, actuator 130 may cause both of second and third valves 136, 138 to move from a closed position to an open position responsive to a user input. In turn, compressed CO₂ flows to additive cartridge slot 126, which pressurizes additive cartridge slot 126 and/or which pressurizes a particular additive cartridge 128 contained within additive cartridge slot 126. This pressure on at least one of additive cartridges 128 causes the cartridge to dispense additive into mixing chamber 138. At the same time, carbonated fluid flows into mixing chamber 138 from carbonation system 120, where it is mixed with the additive before being dispensed.

### In-Line Carbonation

As mentioned above, carbonation system 120 can either be configured for batch carbonation or in-line carbonation. In a batch carbonation configuration, carbonation system 120 generally includes a carbonation tank in which fluid is help and one or more devices that inject CO₂ into the carbonation tank and/or fluid (e.g., carbonation stones). Typically, batch carbonation requires that a predetermined volume of fluid is provided to the carbonation tank, where the entire volume is carbonated and stored until dispensing. However, in an in-line carbonation configuration, the fluid is carbonated on-demand. For example, only a portion of fluid (e.g., one serving) is carbonated as it passes through carbonation system 120 and the carbonated fluid is not stored but dispensed. Accordingly, in-line carbonation can allow for more precise carbonation control (e.g., to meet specific carbonation levels) and a smaller form factor than, for example, a device having a carbonation tank.

Referring now to FIG. 6, a detailed diagram of carbonation system 120 is shown in the in-line configuration mentioned above, according to some embodiments. As in the various configurations described above, the configuration shown in FIG. 6 includes fluid tank 102, pump 108, CO₂ canister 118, first and second pressure regulators 116, 118, and first and second compressed CO₂ pathways 112, 114. For the sake of brevity, these components are not redescribed in detail. At a high level, however, fluid tank 102 is shown to be coupled to pump 108 via first fluid conduit 106. As described above, pump 108 is generally operated by (i.e., powered by) compressed CO₂, as opposed to electricity, for example. Accordingly, compressed CO₂ may be provided to pump 108 via first compressed CO2 pathway 112.

In some embodiments, first pressure regulator 116 controls (i.e., regulates) the pressure of the CO₂ provided via first compressed CO₂ pathway 112. For example, first pressure regulator 116 may maintain the pressure of CO₂ in first compressed CO₂ pathway 112 at or about 90 psi. In some embodiments, CO₂ canister 110 may be coupled first or directly to first pressure regulator 116, as shown. In other embodiments, CO₂ canister 110 is coupled to first pressure regulator 116 via a separate compressed CO₂ pathway, via a coupling, etc. As shown, in some embodiments, second pressure regulator 118 is positioned “downstream” of first pressure regulator 116. For example, second pressure regulator 118 be coupled to first compressed CO₂ pathway 112 (e.g., via a t-fitting). In other embodiments, second pressure regulator 118 is coupled directly to CO₂ canister 110 or an additional compressed CO₂ pathway may extend from CO₂ canister 110 to second pressure regulator 118, such that first and second pressure regulators 116, 118 independently regulate the pressure of CO₂ received from CO₂ canister 110. It will be appreciated that all such possible arrangements of first and second pressure regulators 116, 118 are contemplated herein.

In some embodiments, first pressure regulator 116 may be configured for, or set to, a higher pressure than second pressure regulator 118. For example, first pressure regulator 116 may be set to 90 psi whereas second pressure regulator 118 is set to 72.5 psi. In some embodiments, first pressure regulator 116 and/or second pressure regulator 118 may be adjustable to control the pressure of the CO₂ provided from CO₂ canister 110. For example, first pressure regulator 116 may be adjustable to control the speed of pump 108 and thereby the flow rate of fluid through carbonation system 120.

Taking a closer look at carbonation system 120, pump 108 may optionally be coupled to a pulsation dampener 604 which reduces pulsations in the fluid due to pump 108 and ensures a stable flow of fluid to the rest of carbonation system 120. For simplicity's sake, pump 108, pulsation dampener 604, and the remaining components of carbonation system 120 are described herein as components of a fluid pathway 602. However, it will be appreciated that each component (e.g., pump 108, pulsation dampener 604, etc.) or set of components may be fluidically coupled via individual fluid conduits (e.g., similar to, or the same as, first fluid conduit 106). For example, pump 108 may be coupled to pulsation dampener 604 via a length of tubing or other type of fluid conduit.

In some embodiments, fluid pathway 602 includes a check valve 606 which prevents fluid from flowing back to pulsation dampener 604 and/or pump 108. Optionally, fluid pathway 602 also includes a pressure relief valve 608, which is a safety feature to prevent carbonation system 120 from over pressurizing. In some embodiments, pressure relief value 608 is set to, or configured for, a pressure that is similar the pressure of first pressure regulator 116, as described below, and/or the pressure provided by pump 108. For example, if first pressure regulator 116 is set to 90 psi, pressure relief value 608 may be configured to release at 100 psi. Generally, pressure relief value 608 is selected or set to a pressure that is within about 10% of first pressure regulator 116. In some embodiments, fluid pathway 602 further includes a check valve 610 positioned after (i.e., “downstream”) of pressure relief valve 608 to prevent backflow.

Carbonation system 120 is shown to further include a first Venturi injector 612 and, optionally, a second Venturi injector 614. First and second Venturi injectors 612, 614, also referred to as “Venturi-vortex injectors,” are configured to inject CO₂ into a fluid as the fluid passes through each injector. Put another way, first and second Venturi injectors 612, 614 may mix CO₂ with the fluid using the Venturi effect produced by the flow of the fluid through first and second Venturi injectors 612, 614, which carbonates the fluid. As shown, first and second Venturi injectors 612, 614 may be positioned in-line, such that fluid flows through first Venturi injector 612 before flowing through second Venturi injector 614, thereby increasing the carbonation of the fluid. As shown, each of first and second Venturi injectors 612, 614 may be coupled to second pressure regulator 118 via second CO₂ pathway 114, or another CO₂ pathway. In this manner, both first and second Venturi injectors 612, 614 are fed with CO₂ at a pressure specified by second pressure regulator 118 (e.g., 72.5 psi). It should be appreciated, however, that first and second Venturi injectors 612, 614 may alternatively be coupled to first pressure regulator 116 or another, separate pressure regulator.

Continuing downstream from first and second Venturi injectors 612, 614, carbonation system 120 may include a first filter 616 and, operationally, a second filter 618. In some embodiments, first and second filters 616, 618 are dynamic membrane filters. In some such embodiments, first and second filters 616, 618 may be glass bead filters. It will be appreciated that first and second filters 616, 618 may serve multiple purposes; both to filter the fluid passing through fluid pathway 602 and to disperse or “break down” the CO₂ injected by first and second Venturi injectors 612, 614. For example, the mixing of CO₂ with the fluid by first and second Venturi injectors 612, 614 may result in an uneven distribution of CO₂ within the fluid, or uneven sized and large “bubbles.” Thus, first and second filters 616, 618 may further integrate the CO2 with the fluid, resulting in smaller “bubbles” and a more uniform bubble distribution within the fluid to thereby increases the rate that CO₂ dissolves into the fluid.

Carbonation system 120 is shown to further include a first carbonation stone 620 and, optionally, a second carbonation stone 622. First and second carbonation stones 620, 622 are generally configured to inject/dissolve additional CO₂ into the fluid. In this manner, first and second carbonation stones 620, 622 can increase the carbonation of the fluid. For example, first and second carbonation stones 620, 622 may “fine-tune” the carbonation of the fluid after the initial injection of CO₂ by first and second Venturi injectors 612, 614. For example, the CO₂ injected by the first and second carbonation stones 620, 622 forms bubbles that are smaller than those formed by the first and second Venturi injectors 612, 614 and the first and second filters 616, 618. Accordingly, it will be appreciated that first and second carbonation stones 620, 622 are generally positioned downstream of first and second Venturi injectors 612, 614 and/or first and second filters 616, 618.

By positioning the first and second carbonation stones 620, 622 downstream of the first and second Venturi injectors 612, 614 and/or first and second filters 616, 618, increased carbonation levels are provided in the fluid. For example, the relatively smaller bubbles formed by the first and second carbonation stones 620, 622 are not recombined with the larger bubbles from the first and second Venturi injectors 612, 614 and/or first and second filters 616, 618, which would reduce the rate that CO₂ is dissolved into the fluid by reducing the surface area contact between the CO₂ bubbles and the fluid. In other words, by positioning the first and second carbonation stones 620, 622 downstream of the other components, the CO₂ bubble size continues to decrease, thereby increasing the rate at which CO₂ is dissolved into the fluid. In some embodiments, first and second carbonation stones 620, 622 may include, or be integrated into, t-fittings, such that the fluid can pass through or by first and second carbonation stones 620, 622 while additional CO₂ in dissolved into the fluid. In some embodiments, first and second carbonation stones 620, 622 are 0.5 micron stones.

As described herein, the combination of first and second Venturi injectors 612, 614, first and second filters 616, 618, and first and second carbonation stones 620, 622 can result in absolute carbonation levels of about 3.1 volumes which, after mixing with additives (e.g., at mixing valve 124, mixing chamber 138, etc.) can yield a carbonation of about 2.6 volumes in a dispensed beverage. Notably, it becomes increasingly difficult to dissolve CO₂ into fluid (e.g., water) as the temperature of the fluid increases; thus, the particular arrangement of components shown in FIG. 6 is well-suited for generating a properly carbonated beverage (e.g., around 2.6 volumes of absolute carbonation) at the higher temperatures of residential refrigerators (e.g., around 35° F. to 38° F.), as discussed in greater detail below. It should be appreciated that various combination of first and second Venturi injectors 612, 614, first and second filters 616, 618, and first and second carbonation stones 620, 622 can result in varying carbonation levels. Accordingly, all such combinations of these components are contemplated herein. For example, carbonation system can include one or both of first and second Venturi injectors 612, 614, first and second filters 616, 618, and first and second carbonation stones 620, 622, and in some cases can include additional injectors, filter, and carbonation stones.

In some embodiments, carbonation system 120 may further include a static mixer 624 positioned after (i.e., downstream) of first and second carbonation stones 620, 622. Static mixed 624 may further dissolve the CO₂ injected into the fluid via first and second Venturi injectors 612, 614 and first and second carbonation stones 620, 622. In some embodiments, the static mixer 624 may be omitted. A check valve 626 may be included after static mixer 624 to prevent backflow of the fluid. Further, after check valve 626, a flow compensator valve 628 may be included to set and/or maintain a steady flow of fluid from carbonation system 120 to any downstream components of system 100, including mixing valve 124, mixing chamber 138, etc. In some embodiments, flow compensator valve 628 is manually set (e.g., by a user, during manufacturing, etc.) and/or adjusted. Finally, carbonation system 102 is shown to include a valve 630 that controls the flow of fluid to mixing valve 124, mixing chamber 138, etc. In some embodiments, valve 630 is a ball valve. In some embodiments, valve 630, itself, represents mixing valve 124.

### Example Implementations

Referring now to FIG. 7, a diagram illustrating one example implementation of system 100 is shown, according to some embodiments. In particular, FIG. 7 shows a side view of an example configuration of system 100 with a translucent lower housing 702, in order to illustrate the various internal components of system 100. For example, housing 702 is shown to enclose CO₂ canister 110, first compressed CO₂ pathway 112, first pressure regulator 116, mixing chamber 138, and additive cartridge slot 126. Not shown in FIG. 7, but also enclosed by housing 702, are second compressed CO₂ pathway 114, second pressure regulator 118, and pump 108, which may be positioned on an opposite side of system 100 from what is shown (e.g., behind CO₂ canister 110). Additionally, housing 702 encloses a fitment 704 to which CO₂ canister 110 is coupled, and from which the compressed CO₂ is dispensed throughout the gas system (e.g., first and second compressed CO₂ pathways 112, 114, first and second pressure regulators 116, 118). FIG. 7 also illustrates an outlet 706 of system 100, which is shown to extend from, and be integrated with, mixing chamber 138.

Additionally, FIG. 7 illustrates the flow of fluid through system 100 during operation. For example, prior to a user input (e.g., to actuator 130), a fluid stored in fluid tank 102 (e.g., water) is pulled (1) through filter 104 (2) and into a carbonation tank 708 (e.g., carbonation system 120 or part of carbonation system 120). As described herein, carbonation tank 708 is a vessel (e.g., similar to fluid tank 102) configured to hold a volume of fluid (e.g., received from fluid tank 102) into which compressed CO₂ is injected to carbonate the fluid. Accordingly, once carbonation tank 708 is filled with the fluid (3), the fluid can be carbonated using the compressed CO₂ provided by CO₂ canister 110. Responsive to the user manipulating actuator 130 (e.g., by pressing on actuator 130), the carbonated fluid in carbonation tank 708 is released (4). As the carbonated fluid passes additive cartridge slot 126 (e.g., prior to or when reaching mixing chamber 138), the flow of fluid “pulls” additive from one or more of additive cartridges 128 (5). Within mixing chamber 138, the carbonated fluid and additives are mixed before being dispensed from outlet 706 (6).

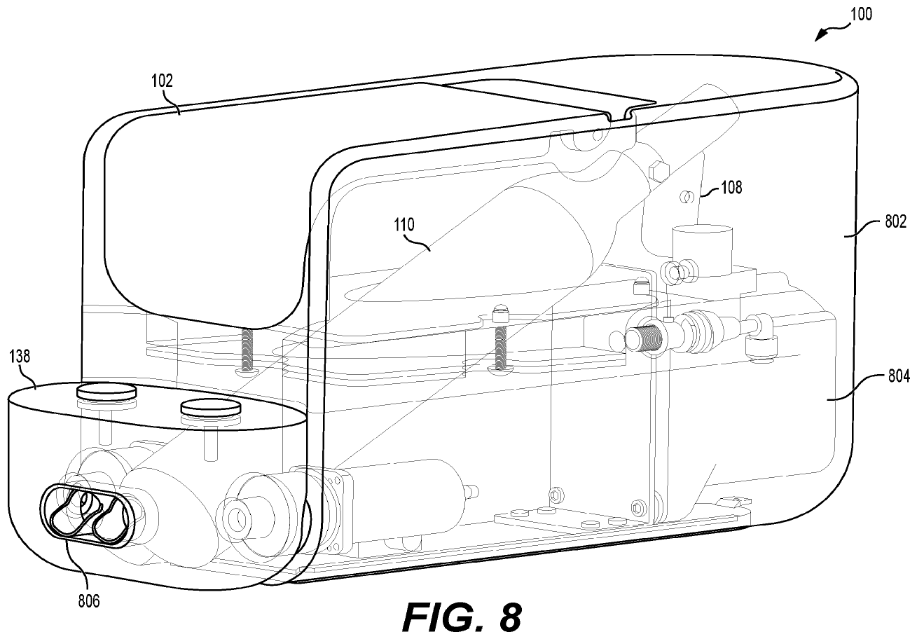

Referring now to FIG. 8, a diagram illustrating an alternative example implementation of system 100 is shown, according to some embodiments. FIG. 8 is a perspective view of an example configuration of system 100 shown with a translucent housing 802 in order to illustrate the various internal components of system 100. Like the implementation shown in FIG. 7, the implementation of FIG. 8 shows that housing 802 encloses CO₂ canister 110; however, in this example, CO₂ canister 110 is shown to be positioned at an angle and extending the length of housing 802. While not explicitly shown, first compressed CO₂ pathway 112, first pressure regulator 116, and/or at least a portion of carbonation system 120 may be enclosed in a fluidics system 804. Further, fluidics system 804 may generally include one or more of second compressed CO₂ pathway 114, second pressure regulator 118, and pump 108. In some embodiments, pump 108 may be positioned near a connector for CO₂ canister 110. For example, pump 108 may extend from the connector for CO₂ canister 110, as shown in FIG. 8.

It should be appreciated that, while particular configurations of system 100 were described above with reference to FIGS. 1-8, any combination of features described in each of the configurations may be used in a further configuration. In other words, any of the features of system 100 described above may be used together to form system 100. As mentioned above, for example, any of the configurations of system 100 shown in FIGS. 1-3 may include mixing chamber 138. Likewise, the configurations of system 100 shown in FIG. 4 or 5 may, for example, include mixing valve 124. As another example, any configuration of system 100 described herein may include an in-line implementation of carbonation system 120 or a carbonation tank style implementation of carbonation system 120.

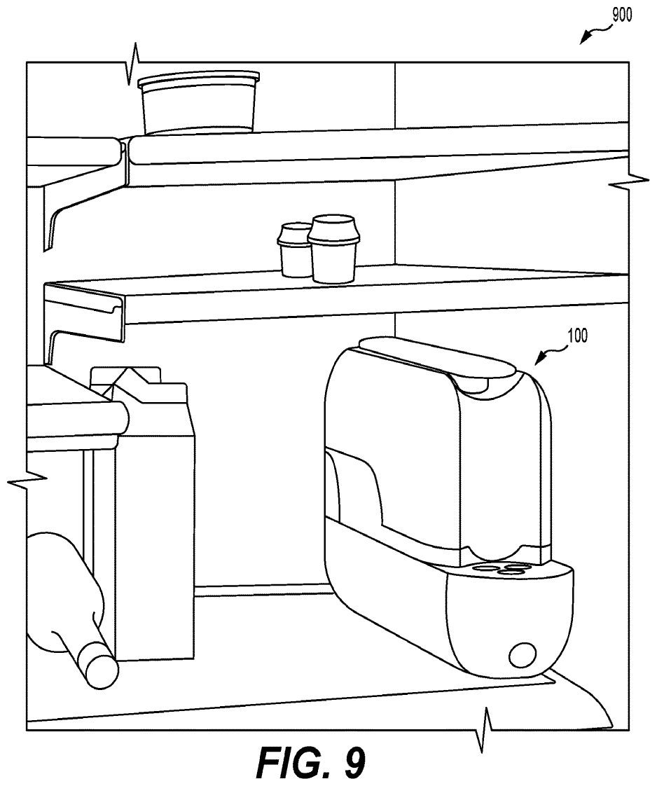

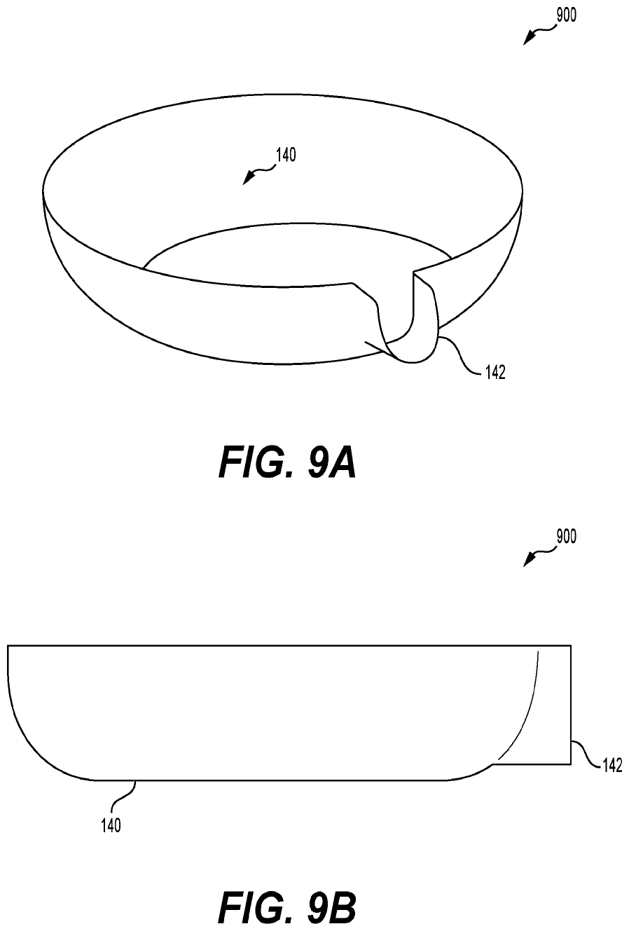

Referring now to FIG. 9 a diagram of system 100 in an example storage environment 900 is shown, according to some embodiments. In this example, environment 900 is a residential refrigerator; although environment 900 may more broadly represent any cooled or chilled environment. A residential refrigerator can typically maintain an ambient, internal temperature below 40° F., and in some case from 35° F. to 38° F. Storing system 100 in a cooled environment, such as environment 900, allows the temperature of the fluid stored in fluid tank 102 to reach an equilibrium with the ambient temperature of environment 900. In other words, the fluid stored in system 100 is chilled to at or around the temperature of environment 900. As mentioned above, this means that system 100 does not require a separate refrigeration system in order to cool the fluid. Rather, system 100 may be entirely mechanical and may rely on placement in a cooled environment (e.g., environment 700) to produced cooled mixed beverages. To this point, system 100 is generally also sized to fit on a shelf of a residential refrigerator, as shown in FIG. 9. To meet this size limitation, CO₂ canister 110 can be positioned horizontally in system 100, as shown in FIGS. 7 and 8, thereby reducing the overall height of system 100.

### Combined Mixing Bowl and Outlet

Referring now to FIGS. 9A and 9B, diagrams of a combined mixing bowl 900 and outlet 142 for mixing a fluid and one or more additives are shown, according to some embodiments. In some embodiments, combined mixing bowl 900 and outlet 142, also referred to herein as mixing bowl 900, collectively, is the “mixing area” (e.g., mixing area 140) of mixing chamber 138, as discussed above. In some embodiments, mixing bowl 900 is formed of a single piece of metal (e.g., stainless steel) or food-safe plastic. Mixing bowl 900 may be configured to receive carbonated fluid (e.g., water) and dispensed additives and, due to the shape and placement of mixing bowl 900, the carbonated fluid and additives may mix in mixing bowl 900. In some embodiments, the flow of the carbonated fluid causes the mixture of the fluid and additives in mixing bowl 900. Additionally, the volume of carbonated fluid in mixing bowl 900 may help to “wash out” any left-over additives (e.g., flavorings) between production of mixed beverages.

Referring now to FIGS. 10A and 10B, example diagrams showing an example implementation of mixing chamber 138 and/or an outlet of system 100 are shown, according to some embodiments. In this example, additive cartridge slot 126 is shown to be positioned above, or on a top side of, mixing chamber 138. Alternatively, a plurality of buttons (i.e., actuators) may be positioned on top of mixing chamber 138 which, when actuated by a user, cause system 100 to mix and dispense a corresponding mixed beverage. FIG. 10B, for example, shows a user pushing on a particular actuator or additive cartridge 128. The mixed beverage may then be dispensed from outlet 706.

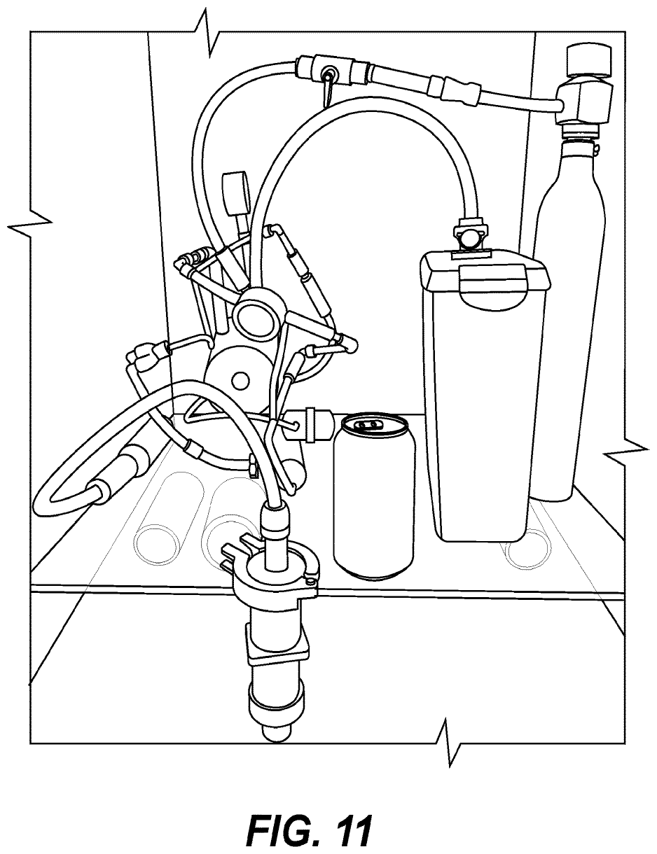

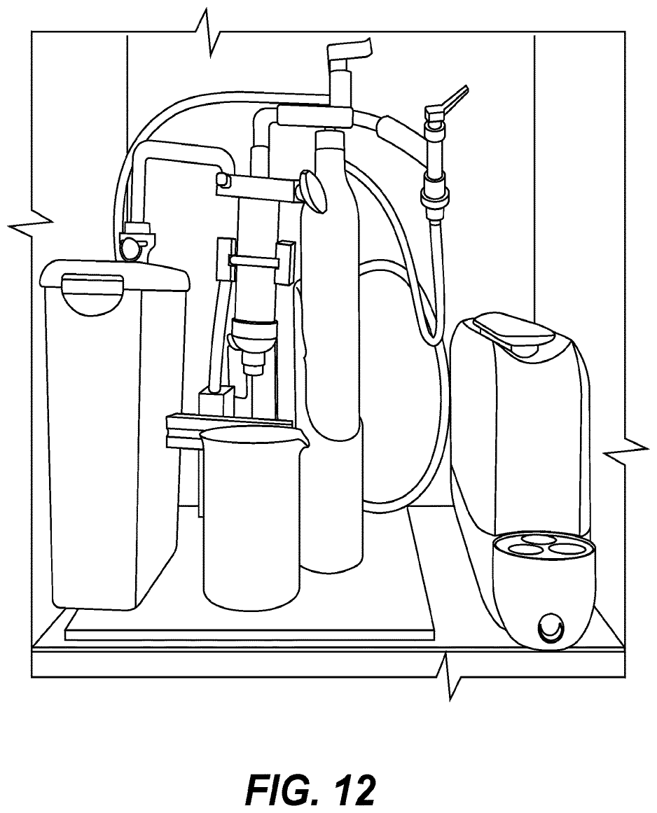

Referring now to FIGS. 11 and 12, example implementations of carbonation system 120 in an in-line configuration and a batch configuration are shown, respectively, according to some embodiments. Specifically, FIG. 11 shows an example of the in-line configuration described above with respect to FIGS. 1-5, and in particular at FIG. 6. FIG. 12 shows an example of a batch carbonation configuration, as described above with respect to FIGS. 1-5.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

Disclosed are components that can be used to perform the disclosed methods and form the disclosed systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

1. A mechanical drink dispensing system comprising:
a first tank for holding a first fluid;
a second tank fluidically coupled to the first tank;
a carbonator fitting adapted to connect to a carbon dioxide (CO₂) tank;
a valve positioned on an outlet of the second tank and configurable between an open and closed position;
an actuator mechanically coupled to the valve and configured to actuate the valve between the open and closed positions upon physical manipulation of the actuator by a user;
a pump for transferring the first fluid from the first tank to the second tank when the valve is in the open position;
a first compressed CO₂ pathway from the carbonator fitting to the pump, wherein the pump is configured to operate by compressed CO₂ gas;
a second compressed CO₂ pathway from the carbonator fitting to the second tank, wherein the first fluid is carbonated by the compressed CO₂ gas in the second tank;
an additive cartridge slot sized to receive one or more additive packages containing one or more additives; and
a mixing chamber comprising a mixing area and an outlet, the additive cartridge slot in fluid communication with the mixing chamber, wherein the mixing area is adapted to receive the carbonated first fluid from the second tank and the one or more additives from the additive cartridge slot when the valve is in the open position, and wherein the outlet is configured to dispense a beverage comprising a mixture of the first fluid and the one or more additives.

2. The system of claim 1, wherein the mixing area comprises a bowl and wherein the outlet is integrated into the bowl.

3. The system of claim 1, wherein the mixing area comprises a second valve fluidically coupled to the additive cartridge slot, and wherein the second valve is a Venturi valve.

4. The system of claim 1, further comprising a linkage that mechanically couples the actuator with the additive cartridge slot, wherein the linkage manipulates the additive cartridge slot to cause at least one of the one or more additives to be dispensed into the mixing area when the actuator is physically manipulated by the user.

5. The system of claim 1, further comprising a third compressed CO₂ pathway from the carbonator fitting to the additive cartridge slot, the third compressed CO₂ pathway comprising a second valve positioned between the carbonator fitting and the additive cartridge slot, wherein the actuator is further mechanically coupled to the second valve and configured to actuate the second valve between an open and a closed position upon physical manipulation of the actuator by the user.

6. The system of claim 1, wherein each of the first compressed CO₂ pathway and the second compressed CO₂ pathway comprise an in-line pressure regulator.

7. The system of claim 1, further comprising a filter for filtering the first fluid, the filter positioned internally to, and at an outlet of, the first tank.

8. The system of claim 1, wherein system is unrefrigerated.

9. The system of claim 1, wherein the system is sized to fit on a shelf of a residential refrigerator.

10. The system of claim 1, wherein the system is configured to be stored in a cooled environment such that the first fluid reaches an equilibrium with a temperature of the cooled environment.

11. The system of claim 10, wherein the temperature of the cooled environment ranges from 35° F. to 38° F.

12. The system of claim 10, wherein the temperature of the cooled environment is below 40° F.

13. A method for mixing and dispensing a carbonated beverage using a beverage dispensing device, the method comprising:
receiving a user input to an actuator of the beverage dispensing device, wherein the actuator is mechanically coupled to a valve of the beverage dispensing device and wherein the user input causes the actuator to actuate the valve from a closed position to an open position;
when the valve is in the open position:
transferring water from a fluid tank of the beverage dispensing device to a carbonation tank of the beverage dispensing device using a pump powered by compressed carbon dioxide (CO₂);
carbonating the water in the carbonation tank using the compressed CO₂;
transferring the carbonated water from the carbonation tank to a mixing chamber of the beverage dispensing device, the mixing chamber comprising a mixing area and an outlet;
dispensing, into the mixing area of the mixing chamber, one or more additives from one or more additive cartridges, wherein the carbonated water and the one or more additives are mixed within the mixing area; and
dispensing, from the outlet of the mixing chamber, the carbonated beverage comprising the mixture of the carbonated water and the one or more additives.

14. The method of claim 13, wherein the one or more additive cartridges are contained within an additive cartridge slot of the beverage dispensing device.

15. The method of claim 14, wherein the mixing area comprises a Venturi valve and wherein the Venturi valve is fluidically coupled to the additive cartridge slot such that the one or more additives are dispensed into the Venturi valve responsive to the carbonated water passing through the Venturi valve.

16. The method of claim 14, wherein the actuator is further mechanically coupled to the additive cartridge slot via a linkage and wherein, responsive to the user input, the linkage manipulates the additive cartridge slot to cause at least one of the one or more additives to be dispensed into the mixing area.

17. The method of claim 13, further comprising filtering the water as the water is transferred from the fluid tank to the carbonation tank, wherein the water is filtered by a filter positioned at an outlet of the fluid tank.

18. The method of claim 13, wherein the actuator is a mechanical actuator.

19. The method of claim 13, wherein the beverage dispensing device is configured to be stored in a cooled environment such that the water reaches an equilibrium with a temperature of the cooled environment.

20. The method of claim 13, wherein the beverage dispensing device is unrefrigerated.
